(19) United States
(12) Patent Application Publication
(10) Pub. No.: US 2016/0342928 A1
(43) Pub. Date: Nov. 24, 2016

(54) BUSINESS ACTIVITY INFORMATION MANAGEMENT

(71) Applicant: SOLVASSURE, Ltd., Brentford (GB)

(72) Inventor: Clive Andrew Godwin, Brentford (GB)

(21) Appl. No.: 15/226,558

(22) Filed: Aug. 2, 2016

Related U.S. Application Data
(63) Continuation-in-part of application No. 14/109,531, filed on Dec. 17, 2013.

(30) Foreign Application Priority Data
Dec. 18, 2012 (GB) 12228664

(51) Int. Cl. G06Q 10/06; G06F 3/0482; G06F 17/28

(52) U.S. Cl. CPC G06Q 10/063114; G06Q 10/0633; G06F 17/289; G06F 3/0482

(57) ABSTRACT

A compliance activity information management and control system and method distributes, collates and tracks automated assurance questions and answers directly from key stakeholders to enable faster decision making, higher quality results and lower delivery costs. Additional features include a question-handling system, an exception reporting system and a social community area. The system also provides a graphical representation in a form of a dashboard on the graphical user interface to assist the management of the facility in managing the facility. Function-specific content, incorporates client and industry best practices.

### TECHNICAL FIELD

The present disclosure relates to compliance activity information management systems, in particular to compliance activity information management systems utilizing a cloud-based computer program product application that enables faster decision making, higher quality results, lower delivery costs and enhanced accountability in a typical business environment. Moreover, the present disclosure concerns methods of handling, distributing, collecting, and tracking questions and answers directly from key stakeholders. Furthermore, the present disclosure is concerned with an exception-reporting tool for the aforesaid systems, wherein the exception-reporting tool is implemented via a user-friendly dashboard providing a graphical user interface. Furthermore, the present disclosure relates to software products recorded on non-transitory, machine-readable data storage media, wherein the software products are executable on computing hardware and mobile devices for implementing the above methods.

### BACKGROUND

Businesses face challenges managing various stakeholders and functions as they continue to grow or transition from one type of operation, product or service offering to another. Common problems faced in managing business organizations include team performance, program delivery, business partner management or regulatory audit. These problems are exacerbated by lack of timely and accurate data to support key decisions. This may lead to poorly informed decision-making, unnecessary delays and overspending in addition to increased delivery and regulatory risk.

The detailed gathering of compliance activity information is a difficult, expensive, frustrating and a time-consuming task. There are many challenges inherent to executing such a task. There are issues associated with collating compliance activity information, for example with collation of data transmitted through meetings, electronic mail, phone calls or data extraction, and management reporting.

Such issues may lead to incomplete and/or obsolete data when finally presented, even if it is possible to gather all desired information. Manual consolidation limits the scope available for performing real-time analysis or historical audits. There is frequently insufficient detail to detect who is ultimately accountable for any identified issues. Presentation media may vary significantly, making it difficult to compare like-for-like across different departments and personnel. Emailed reports may not be directed at the appropriate audience or may be delivered into the wrong hands. This inevitably results in poorly informed decision-making, unnecessary delays and overspending, and potentially increases delivery or even regulatory risk.

There are also issues related to a large amount of regulatory statements and rules that businesses have to comply with and which constantly change at a fast pace. Businesses lack time and resources to apply necessary processes to follow all of the rules and statements and take required actions. Such non-compliance results in high fines.

There has been a growth in availability of various types of tools, concepts, and systems which aim to address the aforementioned challenges. When utilizing such tools, information is collated from databases and individuals.

There are six key types of known organisational reporting which comprise a delivery mechanism and associated data content: Metric Management, Dashboards, Balanced Scorecards, Ad Hoc Analyses, Interactive Querying, Data Mining & Advanced Statistics.

Existing systems offer different elements with varied benefit. Some specialize in question-delivery software for market research, some provide business intelligence systems to analyse operating data, others deliver online project management capability. Such systems are herewith detailed with their respective categories in Table 1:

TABLE 1
Known systems

| Parameter | Detail | Main suppliers |
|---|---|---|
| KPI Providers | Key Performance | www.kpilibrary.com |
| | Indicators are commonly | www.ap-institute.com |
| | used by organisations | www.kpistandard.com |
| | to evaluate success in | |
| | predefined activities. | |
| Online Surveys | Questionnaire software | www.surveymonkey.com |
| | is used to collate data | www.keysurvey.co.uk |
| | from multiple recipients, | www.snapsurveys.com |
| | usually for market | |
| | research, product or staff | |
| | surveys. This is an internet | |
| | surveying technique in | |
| | which the interviewee | |
| | follows a script provided by | |
| | a website. | |
| Consultants | Firms of various sizes | www.kpmg.com |
| | provide assurance | www.deloitte.co.uk |
| | consulting services | www.accenture.com |
| | which generally focus | |
| | on project audit and risk | |
| | assessment. They involve | |
| | one-off manual reports | |
| | which are generated from | |
| | information gained during | |
| | face-to-face meetings with | |
| | relevant senior and junior | |
| | stakeholders. | |
| Regulatory | Regulatory software is | www.accelus. |
| | an online risk and audit | thomsonreuters.com |
| | solution for regulators and | www.icomply.com/au |
| | corporations with complex | www.metricstream.com |
| | regulatory and legislative | |
| | compliance requirements. | |
| Project | Online project and portfolio | www.atlassian.com |
| Management | management (PPM) | www.innotas.com |
| | systems provide tools to | www.attask.com |
| | manage activity planning, | |
| | task tracking, risks and | |
| | issues, product delivery, | |
| | resource collaboration and | |
| | project reporting. | |
| Function | Function specific software | www.ebrp.net |
| Specific | focuses on a particular | www.successfactors.com |
| | area of a business. | www.novatus.com |

However, known systems are unable to provide an inclusive solution. No known products automatically interrogate stakeholders to collate and track real-time compliance activity information and present exceptions in an interactive dashboard.

Therefore, there is a need in the art for a system and method to provide a solution for optimizing compliance activity information, which presently is a time-consuming manual process, wherein known systems generate output from incomplete and obsolete data, provide limited real-time analysis and auditing functionalities, with insufficient stakeholder accountability, and non-standard presentation media, which is unstructured and distributed in a non-secure manner.

### SUMMARY

The present disclosure can be applied to any industrial or public sector organization, addressing inadequacies of contemporary systems. The present disclosure provides an inclusive cloud-based solution which distributes, collates and tracks automated assurance questions and answers directly from key stakeholders, thereby enabling faster decision making, higher quality results, lower delivery costs and enhanced accountability. Additional features include a question-handling system, and an exception reporting system. A social community area as well as function-specific assurance question content, incorporating client and industry best practices may also be included.

According to a first aspect of the present disclosure, there is provided a compliance activity information management and control system including computing hardware arranged to execute one or more software products recorded on machine-readable data storage media. The computing hardware is coupled to an input portal to receive input information from an industrial facility, to an output portal for outputting information to the industrial facility, to a graphical user interface for providing information to management of the facility, and to a mobile device, a laptop or a desktop to track and record real time user activity. This includes attachment to a mobile device to enable tracking of user activity with global positioning system technology. To facilitate real time tracking of users an attachment to a laptop or desktop device is also included to enable recording of user activity with camera technology.

Additionally, the computing hardware is operable to map regulatory statements and/or rules to a compliance activity information management and control system. Further, the computing hardware is operable to analyse the regulatory statements and/or rules to determine impact on the facility.

Additionally, the computing hardware is operable to determine a plurality of compliance activities, and a plurality of users, wherein at least one compliance activity from the plurality of compliance activity is assigned to at least one user of the plurality of users. Further the computing hardware is operable to apply filters based on regulatory statements and/or rules to the input information to extract, by analysis thereof, information elements describing time-critical processes occurring within the facility. These information elements are aggregated together with supporting information pertinent to the time-critical processes.

Additionally, the computing hardware is operable to determine a plurality of questions, wherein the plurality of questions is derived from the information elements and corresponds to reusable assurance content.

Additionally, the computing hardware is operable to assign at least one question from the plurality of questions to the at least one user and to track location of the at least one user and store a response of the at least one user to the at least one questions and the tracked location on real time basis.

Additionally, the computing hardware is operable to determine a tolerance level corresponding to the response of the at least one user and the computing hardware is operable to provide a graphical representation of a dashboard on the graphical user interface to facilitate management of the facility, wherein the graphical representation corresponds to at least one exception derived from the tolerance level.

Further, the computing hardware is operable to facilitate management of the facility by generating reminders for management, summary reports and status reports pertaining to the facility on the dashboard on the graphical user interface.

Additionally, the computing hardware is operable to send additional question or an alert to the at least one user to ensure accountability when the tolerance level is above a threshold tolerance.

Additionally, the computing hardware is operable to:

define a project including a first set of compliance activities from the plurality of compliance activities;
determine a first set of questions from the plurality of questions for the project;
determine a first group of users from the plurality of users, wherein the first set of questions are sent to the first group of users at a predetermined time;
receive responses from the first group of users to the first set of questions;
collate tolerances of the respective responses; and
present exceptions to a management user on the dashboard, wherein the exceptions are derived from the tolerances.

Additionally, the computing hardware is operable to define a hierarchy for each of the plurality of compliance activities, the plurality of questions and the plurality of users.

Additionally, the computing hardware is operable to receive instructions from the management for executing control of the facility; and to execute supportive automatic control and oversight of the facility.

Additionally, the computing hardware is operable to track and record activity of a user.

The present system may be applied to commercial business, manufacturing facility, technical production apparatus, or technical processing apparatus.

The filters based on regulatory statements and/or rules may be at least one of: user-configurable by the management and automatically configurable based on identified processes occurring within the facility.

The dash board may present one or more processes or tasks pertaining to the facility, wherein the one or more processes or tasks are represented by graphical symbols arrangement within a Cartesian frame of reference having a first Cartesian axis denoting priority rating of the one or more processes or tasks, and a second Cartesian axis denoting status of the one or more processes or tasks. The first Cartesian axis is also able to switch to denoting a “days late” rating of the one or more processes or tasks. This Cartesian axis can also be displayed as a 3D object to view additional parameters.

The dash board may be individually user-configurable and may support a plurality of management users via individual or group logins.

The computer hardware may be operable to automatically generate at least one of:

(a) reminder messages;
(b) automated communication templates for management to employ when controlling the facility; and
(c) workflow functions which link consecutive regulatory statements and/or rules based activities together.

The computer hardware may be operable to import data automatically from plurality of third party systems.

The computer hardware may be operable to translate questions and answers into different languages.

The computer hardware may include camera based technology to track and record real time activity of users.

According to a second aspect of the disclosure, there is provided a method of operating a compliance activity information management and control system including computing hardware arranged to execute one or more computer program products recorded on non-transitory, machine-readable data storage media. The computing hardware is coupled to an input portal to receive input information from an industrial facility, to an output portal for outputting information to the industrial facility, and to a graphical user interface for providing information to management of the facility.

Additionally, the computing hardware employed to implement the method is operable to determine a plurality of compliance activities, and a plurality of users, wherein at least one compliance activity from the plurality of compliance activity is assigned to at least one user of the plurality of users; apply filters based on regulatory statements and/or rules to the input information to extract, by analysis therefrom and together with supporting information pertinent to the time-critical processes, information elements describing time-critical processes occurring within the facility, together with supporting information pertinent to the time-critical processes; determine a plurality of questions, wherein the plurality of questions is derived from the information elements and corresponds to reusable assurance content; assign at least one question from the plurality of questions to the at least one user; track location of the at least one user and store a response of the at least one user to the at least one questions and the tracked location on real time basis; determine a tolerance level corresponding to the response of the at least one user; and provide a graphical representation of a dashboard on the graphical user interface to facilitate management of the facility, wherein the graphical representation corresponds to at least one exception derived from the tolerance level.

The computing hardware is operable to generate reminders for management, summary reports and status reports pertaining to the facility. The computing hardware receives instructions from the management for executing control of the facility. The computing hardware executes supportive automatic control and oversight of the facility. The computing hardware tracks and records activity of an user.

The facility includes at least one of: commercial business, manufacturing facility, technical production apparatus and technical processing apparatus. Such apparatus and facilities have technical effect, and the present disclosure constitutes an extension of control systems which control application of the technical effect.

The filters based on regulatory statements and/or rules may be at least one of: user-configurable by the management, automatically configurable based on identified processes occurring within the facility.

The dash board presents one or more processes or tasks pertaining to the facility, wherein the one or more processes or tasks are represented by graphical symbols arrangement within a Cartesian frame of reference having a first Cartesian axis denoting priority rating of the one or more processes or tasks, and a second Cartesian axis denoting status of the one or more processes or tasks. The first Cartesian axis is also able to switch to denoting a “days late” rating of the one or more processes or tasks.

The dash board may be individually user-configurable and may support a plurality of management users via individual or group logins.

The computer hardware may be operable to generate automatically at least one of:

(d) reminder messages;
(e) automated communication templates for management to employ when controlling the facility; and
(f) workflow functions which link consecutive regulatory statements and/or rules based activities together.

The computer hardware may be operable to import data automatically from plurality of third party systems.

The computer hardware may be operable to translate questions and answers into different languages.

The computer hardware may include a camera based technology to track and record real time activity of users.

The method may be implemented by a computer program product recorded on non-transitory, machine-readable data storage media, characterized in that the software product is executable upon computing hardware for implementation.

It will be appreciated that features of the disclosure are susceptible to being combined in various combinations without departing from the scope of the disclosure as defined by the appended claims.

### BRIEF DESCRIPTION OF THE FIGURES

Embodiments of the present disclosure will now be described, by way of example only, with reference to the following diagrams wherein:

FIG. 1 is an illustration of a high level architecture of an example compliance activity information management and control system implemented pursuant to the present disclosure;

FIG. 2 is an illustration of an example compliance activity information management and control system for use in management of a facility;

FIG. 3 is a view of an example output portal graphical user interface;

FIG. 4 is a view of an example dashboard;

FIG. 5 is a view of other various example dashboards;

FIG. 6 is a view of a tracking system employing a global positioning system; and

FIG. 7 is an illustration of exemplary steps of a method of operating a compliance activity information management and control system for use in management of the facility.

In the accompanying figures, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

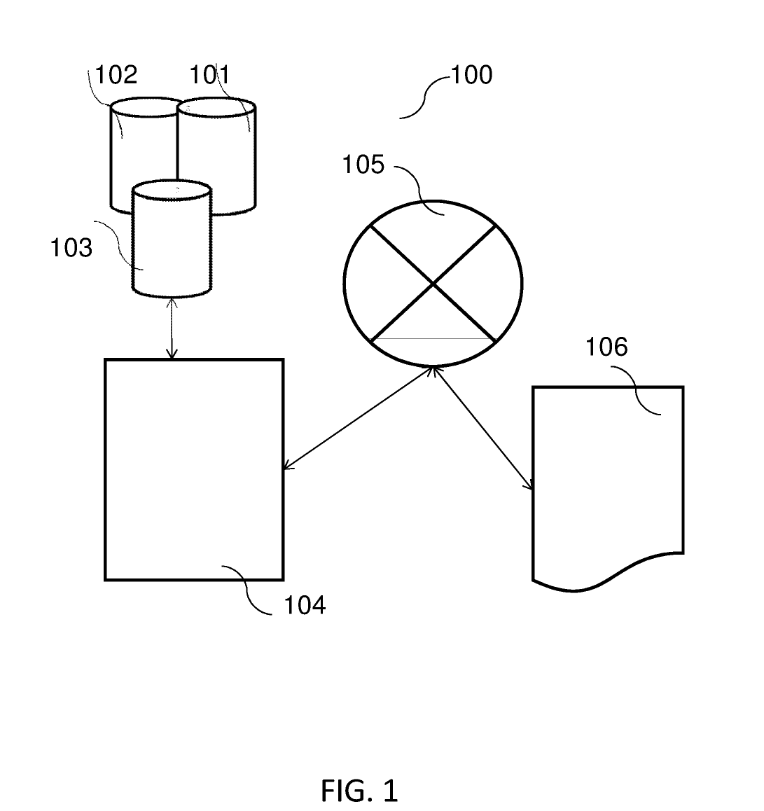

Referring to FIG. 1, there is shown is an illustration of a high-level architecture of a compliance activity information management and control system 100 for managing a facility such as a commercial business, a manufacturing facility, a technical production apparatus, a technical processing apparatus, to mention a few examples. By way of example, the compliance activity information management and control system 100 may be employed for monitoring an organization, managing and running an assurance program, training, monitoring activities, and tracking geographical positioning of a user, and storing, indexing, processing, importing, and analyzing data related to the facility. However, it will be appreciated that system 100 can be used for various facilities.

compliance activity information management and control system 100 may utilize a server system to map regulatory statements and/or rules to the compliance activity information management and control system, analyse the regulatory statements and/or rules to determine impact on the facility and determine a plurality of compliance activities, and a plurality of users, wherein at least one compliance activity from the plurality of compliance activity is assigned to at least one user of the plurality of users. In an embodiment, the compliance activity information management and control system 100 comprises three system components 101, 102 and 103 which may have further hierarchy namely activities 101, questions 102, users 103. Activity hierarchy 101 defines one or more compliance activities that the organization is undertaking. Questions 102 include reusable assurance content that the organization will apply. Furthermore, the users' hierarchy 103 determines one or more access rights for each user type. System 100 utilizes the server system based on computer hardware 104 which may be employed to apply filters based on regulatory statements and/or rules 105 and output information to a graphical user interface 106 for providing information to management of the facility or other users. Filters based on regulatory statements and/or rules 105 extract information elements describing time-critical processes occurring within the facility, together with supporting information pertinent to the time-critical processes. The questions 102 are derived from the information elements and correspond to the reusable assurance content.

In an embodiment, the present disclosure facilitates migration and mapping of regulatory statements and/or rules which may be received from a third party source. Subsequently, the migrated regulatory statements and/or rules are used in combination with the filters based on regulatory statements and/or rules 105 to the input information in order to generate the information elements. For example, the compliance activity information management and control system 100 may analyse data, determine parameters and map the rule (of third party) to respective parameters in the system 100. Further, the compliance activity information management and control system 100 can be employed for various industries which may have relatively complex or simpler assurance activities.

The compliance activity information management and control system 100 may assign one or more questions to the at least one user. Further, the compliance activity information management and control system 100 tracks location of the at least one user and store a response of the at least one user to the one or more questions and the tracked location on a real time basis. The system 100 is adapted to determine a tolerance level corresponding to the response of the at least one user. The tolerance level may correspond to an action category which the management may take in view of the response submitted by the user.

The compliance activity information management and control system 100 provides a graphical representation of a dashboard on the graphical user interface to facilitate management of the facility, wherein the graphical representation corresponds to at least one exception derived from the tolerance level. For example, if the tolerance level is low, the system 100 may consider the response as an inadequate. Accordingly, the system 100 may send additional questions to the user to determine details of the user's activity at the tracked location. Alternatively, the system 100 may alert the management to ensure accountability when the tolerance level is above a threshold tolerance.

Further, the system 100 may define a project that includes a first set of compliance activities derived from the plurality of compliance activities in accordance with a nature of the project. The system 100 may determine a first set of questions for the project and determine a first group of users from the plurality of users, wherein the first set of questions are sent to the first group of users at a predetermined time. The system 100 receives responses from the first group of users to the first set of questions and collates tolerances of the respective responses. Further, the system 100 presents exceptions to a management user on the dashboard, wherein the exceptions are derived from the tolerances.

Compliance activity information management and control system 100 may generate reminders for management, summary reports and status reports pertaining to the assurance program. Compliance activity information management and control system 100 may be accessed via known communication means such as the Internet, cellular operator networks, Intranets or may be distributed as a cloud based service. Compliance activity information management and control system 100 may be operated as an automated assurance system designed to give business sponsors real-time verification that their initiatives are achieving predefined schedules, budgets and quality objectives.

System 100 may further incorporate client- and industry-specific measurement of adherence to critical activities, processes and standards and produce timely and accurate exception data which enables faster decision making, higher quality results and lower delivery costs. In an embodiment, the system 100 may apply machine learning algorithms to automatically generate information which may be industry specific or assurance activity specific. The system 100 is adapted to increase efficiency through the machine learning algorithms. Further, as the size of the data for processing grows, the system 100 becomes more efficient. For example, the system 100 is able to identify patterns and remove deficiency using the self-learning machine algorithms and subsequently, enable the management to take appropriate actions in a timely manner.

Further, the system 100 enables the management to reduce operational cost by reducing insurance premiums. For example, an insurance provider can assess whether to underwrite the facility, to assess the potential of the company to fail. As the insurance premium depends on the risk involved in insuring the business, the system 100 lowers the risk for the business. The exception reporting of the system 100 at the management user level or at a basic user level enable the system 100 to minimize the risks and take corrective actions.

Furthermore, the system 100 is adapted to generate benchmarking data for insurance for a particular industry. The benchmarking data may be used by the insurance provider to generate insurance premiums for the particular industry or identify risk patterns within the particular industry. Accordingly, the insurance provider may utilize data to develop benchmarking of similar companies within the particular industry.

Further system 100 is an online product that provides assurance content and automatic interrogation of stakeholders to collate and track real-time compliance activity information from snapshot questions, thereby presenting filtered exceptions in an interactive dashboard. System 100 may be supported by consulting services.

Further system 100 is an online product that provides assurance content and automatic interrogation of stakeholders to collate and track real-time compliance activity information from snapshot questions, thereby presenting filtered exceptions in an interactive dashboard. System 100 may be supported by consulting services.

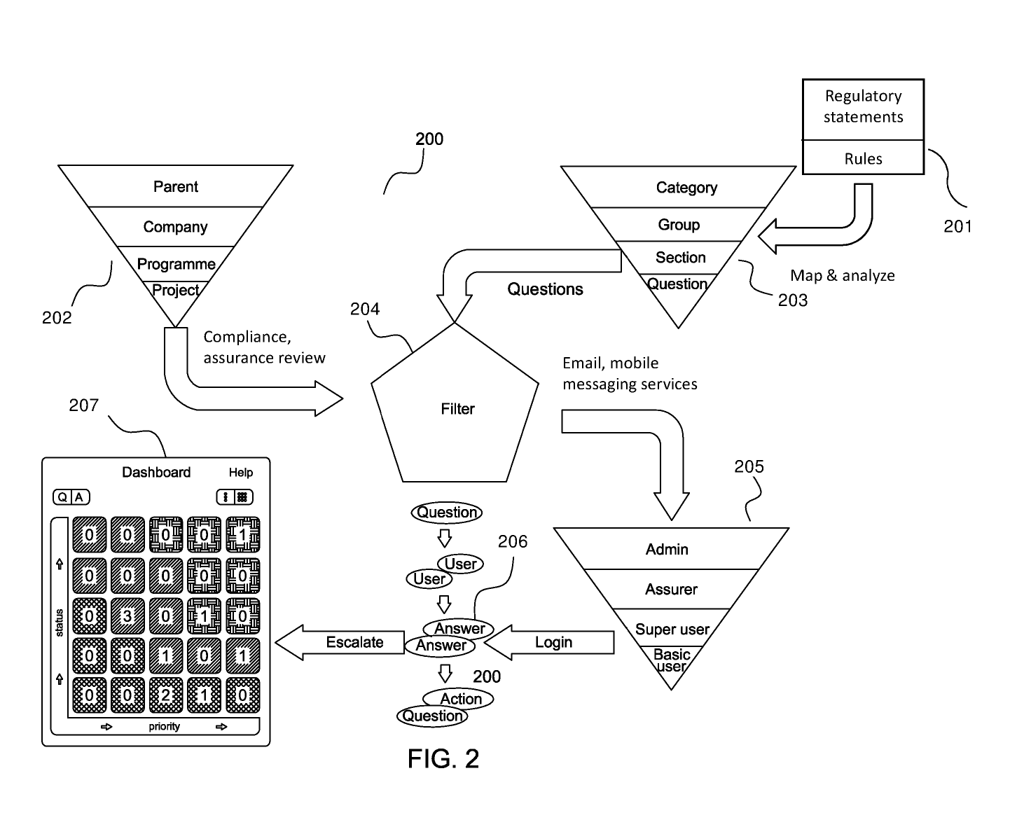

Referring to FIG. 2, there is shown an illustration of an example compliance activity information management and control system 200 used for management of the facility, wherein an activity hierarchy 203 defines the compliance activities that the organization is undertaking. At the top of this hierarchy, a Parent Company may be included to establish existing subsidiary companies or partners. Second-in-line are operating Companies which can be established independently without a Parent Company, where appropriate. Third-in-line are the Program. These are the high level activities that take place within a company or organisation. Fourth-in-line are the Projects which are the lower level activities that take place within each Program. The terms described here are not limiting and the name and categories may be re-labelled, as appropriate. The hierarchy levels are not limited to numbers and may include additional levels based on the application of the system 200.

A second component of the compliance activity information management and control system 200 concerns regulatory statements and/or rules 201 which are mapped and analysed to determine impact on the facility. Such regulatory statements may be specification, policies, standards, law and methodology provided by 3^{rd} party regulatory and professional bodies as well as individuals. Rules could be industry specific information e.g. government project methodologies as well as any information provided by financial conduct authorities, prudential regulation authorities, care quality commissions or specialist consulting firms.

A third component of the compliance activity information management and control system 200 concerns a questions hierarchy 203 which may optionally contain the reusable assurance content that the organization will apply in any assurance program. At the top of this hierarchy are question categories. Second-in-line are Question Groups that reside within each Category. Third-in-line are Question Sections that reside within each Group. Finally, the assurance Questions themselves reside within each Section. The terms described here are not limiting and the name and categories may be re-labelled as appropriate. The hierarchy levels are not limited to numbers and may include additional levels based on the application of the system. A fourth component to compliance activity information management and control system 200 concerns a users hierarchy 205 which determines access rights for each user type. At a top of this hierarchy are Administrators. These types of users have authority over the entire system 200 and are responsible for setting up and maintaining the company and user data and providing first line support. They also take an active part in responding to Questions 203 and Activities 202, where relevant. Second-in-line are Assurers. These users are responsible for creating and running the day-to-day business assurance activities. They also take an active part in responding to Questions 203 and Activities 202 where relevant. Third-in-line are Super Users. These users are nominated Sponsors, Managers or Stakeholders who have visibility over any activities to which they have been attached. They also take an active part in responding to the Questions 203 and Activities 202 where relevant. Last-in-line are Basic Users whose only responsibility is to respond to Questions and Actions, where relevant. The terms described here are not limiting and the name and categories may be re-labelled as appropriate. The hierarchy levels are not limited to numbers and may include additional levels based on the application of system 200. From the Activities Hierarchy 202 described earlier, a Project is selected. An assurance Review is then created over that Project which defines what Questions will be included, when they will be transmitted and who the Recipients are. Reviews may be initiated by a Calendar date or User instruction. Questions are then selected from the Questions Hierarchy on a mix-and-match basis and allocated to the Review. Each Question is defined by parameters which determine its characteristics. A few exemplary questions include:

(a) whether or not the Question is triggered by a Date or the Answer to a previous Question;
(b) who the Recipients are: Single, multiple or pre-defined User Groups;
(c) who in the command chain is authorized to view any exceptions relating to this Question;
(d) the number of days in advance the Question will be sent to give the Recipient additional time to respond;
(e) the number of days grace the Recipient has to answer the Question after it has been transmitted;
(f) the Answer Type configuration for each Question (single answer, multiple choice, percentage measurements, value selection, etc.);
(g) the Priority of the Question which determines where it will appear on the Dashboard;
(h) any attachments that may need to be transmitted with the Question (templates, etc.); and
(h) GPS location.

These Parameters trigger consolidated electronic mail messages and/or mobile messaging services which are automatically sent to Users depending upon Notification settings. Alternatively, an icon on the user device can indicate that there is an activity in need of attention. Upon instruction from the electronic mail, mobile messaging services and/or icon, the Users log into the system 200 to view their Questions and provide Answers. Each Answer is also defined by a Status which determines whether or not it falls outside tolerance and is escalated to the Dashboard. An Answer may generate an Action if it is outside Tolerance, or it may generate another Question if it is based on regulatory statements and/or rules. The data is then filtered and escalated to the Dashboard for real time interrogation. This fully automated Question/Answer/Action process continues until the Review end date is reached.

With an icon, system 100, 200 may reduce or altogether eliminate use of electronic mail. An icon or similar button may be provided on a mobile device, tablet, laptop or desktop environment that presents important tasks or notification calling a user to Action. Further, system 100, 200 also recovers lost password via electronic mail or mobile messaging services. System 100, 200 provides a new pop up or window in case an urgent Question needs to be Answered. An icon provided in system 100, 200 may also notify any pending Question which the user needs to Action.

In an example, system 100, 200 can be set up by following outlined steps. In a first step, the company's existing assurance framework is evaluated to determine the scope, activities, timescales, risks, resource requirements, costs and benefits associated with the implementation. If the system is beneficial for the company system 100, 200 also evaluates the division where system 100,200 will be installed. The processes of system 100, 200 are mapped to ensure that pre-defined quality objectives are achieved, changes to functionality are agreed upon, an implementation plan is drafted and acceptable for be roll-out across the company. In a second step, the company nominates at least two suitable Administrators who are trained to maintain and run system 100, 200. Relevant company settings data is then manually compiled including Users, User Groups, Locations, Location Types, Departments, Roles, Naming Settings, Working Days and Notification statements. In a third step, the company is then created and template data copied from the system or service provider before the settings are entered and verified. In a fourth step, the User Hierarchy is created by defining which users are Assurers, which are Super Users and which are Basic Users before the user data is entered and verified.

The Activity Hierarchy is then created by defining which Programmes and Projects are to be included in the automated assurance process before the data is entered and verified. The Question Hierarchy is then created by defining the assurance content to be included before the data is entered and verified. Some template content will already have been copied from the system or service provider when the company was created. A preliminary review is established in a controlled environment to test the new system. Changes to processes and functionality are agreed and implemented. Relevant Stakeholders are briefed to ensure an understanding not only of what the system does, but why it is being implemented. Finally, end user training is carried out before the pilot is extended.

In an example, in respect of hierarchy structures 202, 203, 205, data visibility can be restricted depending upon Activities to which a user is assigned. In this example, there are two assurance Programs running. Program 1 may be Business-as-Usual performance monitoring and Program 2 may be Call Centre relocation for example. Program 1 is associated with four Projects and Program 2 is associated with three Projects and these would be established in the Activity Hierarchy. The Administrator in the User Hierarchy has visibility over all Programs in the Company and all Projects within each Program. The Super Users and Assurers have visibility over assurance activities relating to any Program or any individual Projects to which they are attached but cannot see assurance activity relating to any Programs or Projects to which they are not attached. The assurance Questions are generated from each Project and at the lowest level, Basic Users are only authorized to see the Questions and Actions that have been assigned to them from relevant Projects.

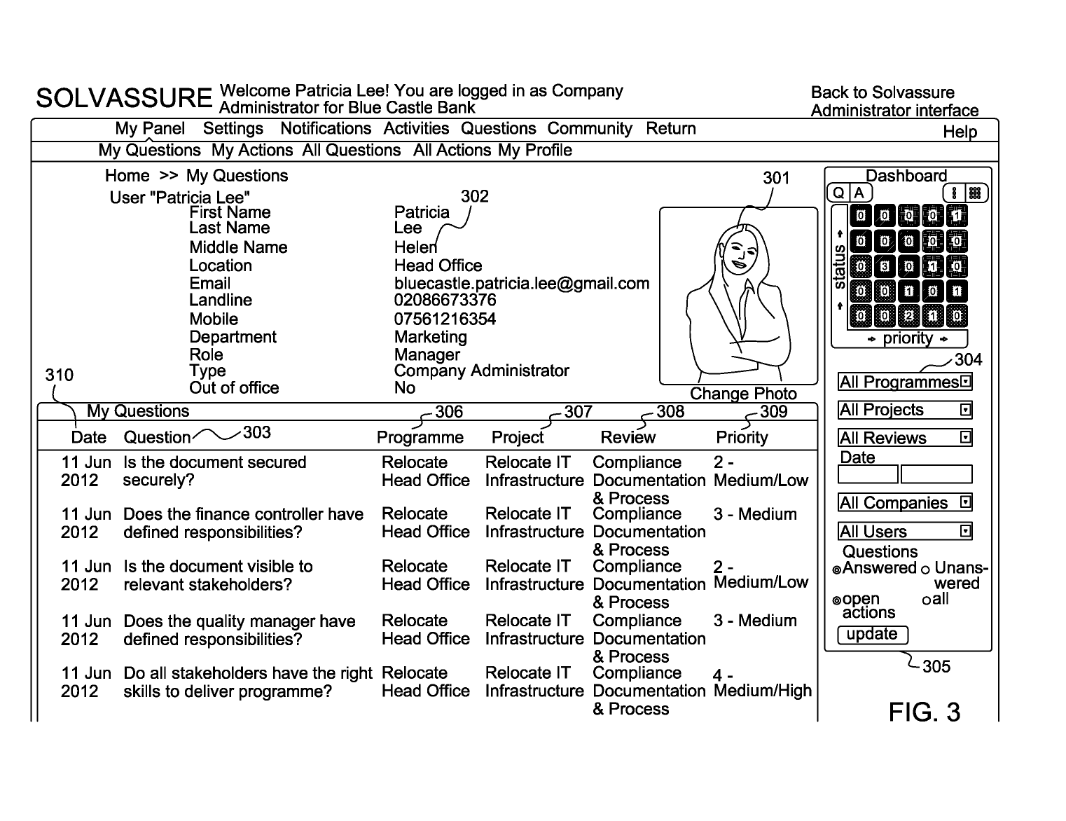

Referring next to FIG. 3, there is shown a view of output portal graphical user interface for reporting critical compliance activity information and using such as processes. A company logo and menu options are included at the top 300 of the graphical user interface. A MI Dashboard which is personal to each user and appears on every screen is included to the right 304 of the graphical user interface. Core data, in this case there are Questions relating to Users 306, 307, 308, and 309, is included in a main body 303 of the graphical user interface. Parent data is included in a drop down header 305. With reference to FIG. 3, a User Profile is presented.

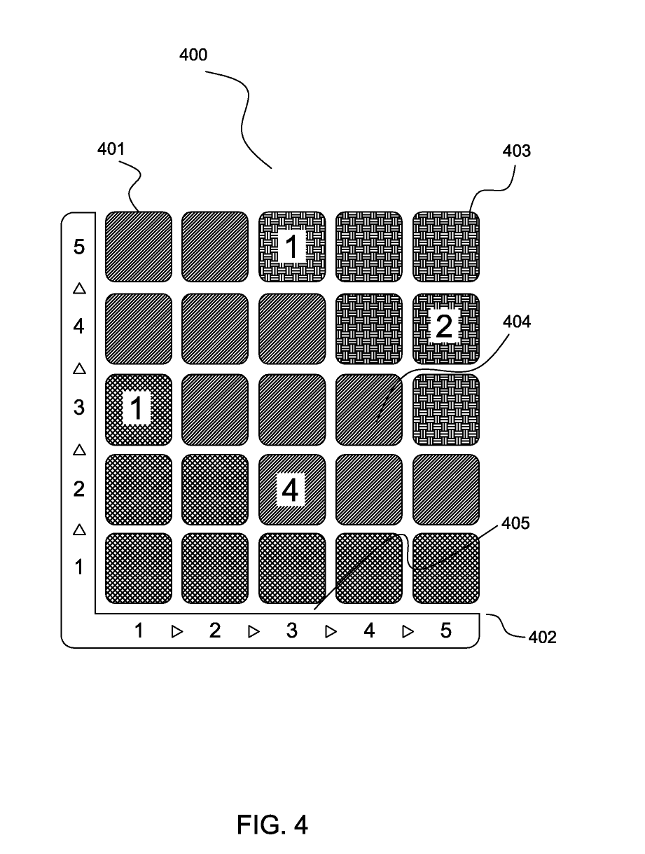

Referring next to FIG. 4, there is shown an illustration of a dashboard used for reporting critical compliance activity information such as processes or tasks pertaining to the facility. Processes or tasks are represented by graphical symbols 403, 404, 405 that are arranged within a Cartesian frame of reference having a first Cartesian axis denoting priority rating 402, and a second Cartesian axis denoting status of the one or more processes or tasks 401. The users can customize the dashboard using their individual or group logins in various arrangements. Circles 403, 404, and 405, beneficially implemented in red/amber/green colors respectively, include the quantity of Review Questions that reside within that Status/Priority combination for that user's authority. For example, Status 5/Priority 5 Review Questions reside in the top right hand circle, and so forth. The user can make selection of Review data with that Priority/Status or Priority/Days Late combination will be displayed in the central display. The dashboard display 400 can be switched between a 25-button grid, a 3-button grid and a 1-button grid by selecting the display icon. The dashboard display can also be switched between Questions and Actions by selecting a Q/A icon. The axis or graphical symbols may vary in accordance with user needs, and are not limited to the illustrated example. The axes are optionally interchangeable and may include user defined labels, levels or description.

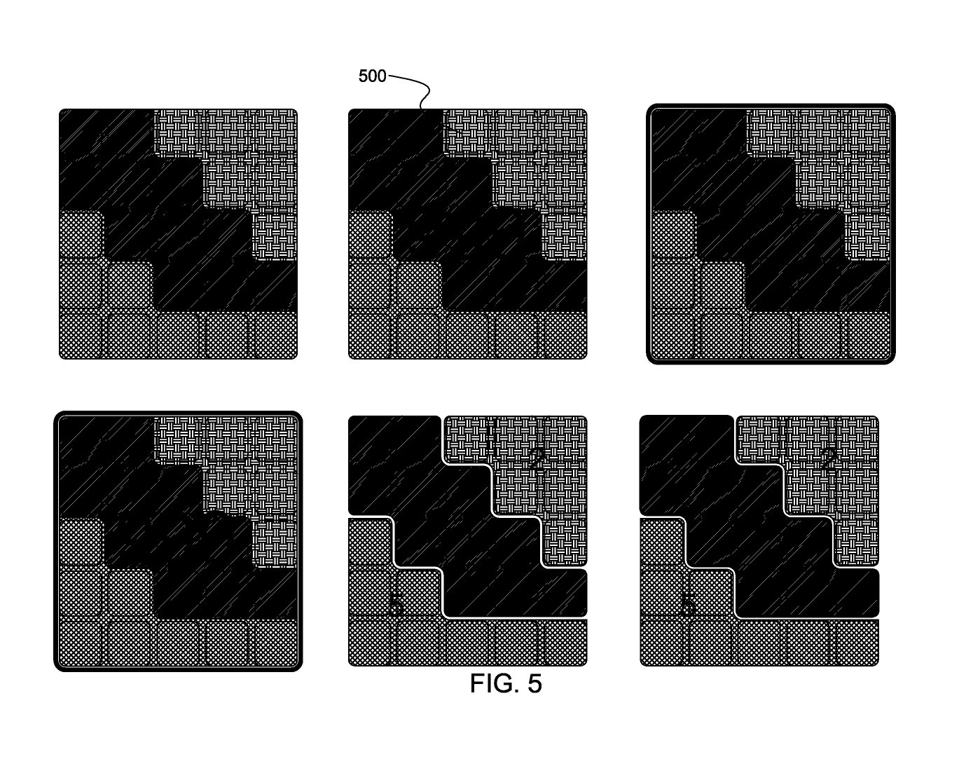

Referring to FIG. 5, there is shown an illustration of a various-user configurable dashboard. However, these are not limited to the illustrated drawing. The users can customize the dashboard using their individual or group logins in various arrangements. The axis or graphical symbols may vary as per user needs and are not limited to the illustrated example.

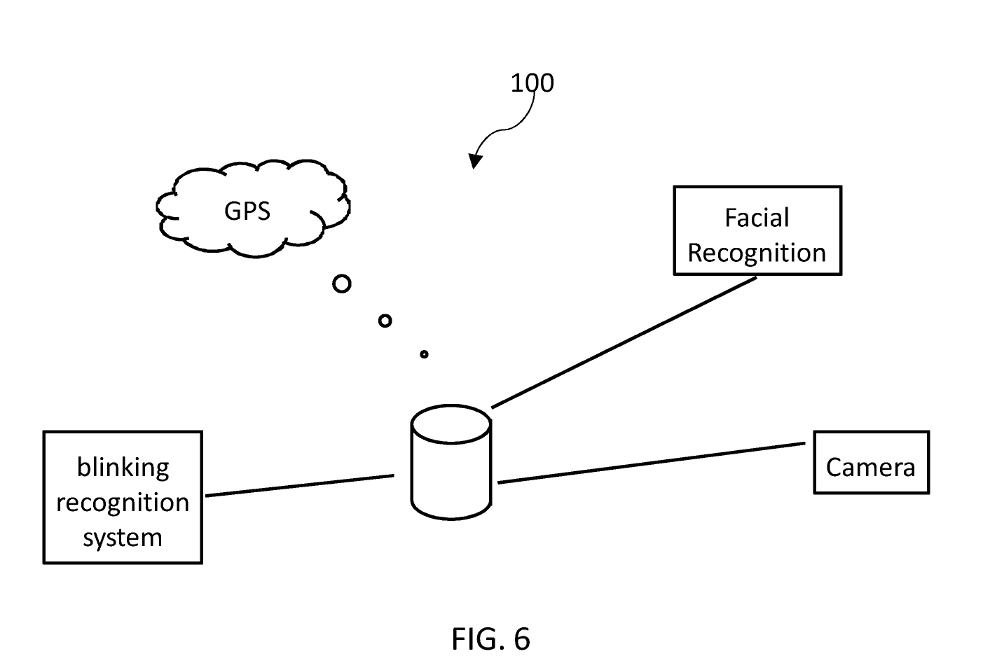

In some examples, the compliance activity information management and control system 100 can be set up to monitor or track remote workers. FIG. 6 is a view of a tracking system employing a global positioning system. Use of cameras, GPS enabled technology, face recognition systems, blinking recognition systems and other state of the art technologies provides real time tracking of user activity. Tracked activity may be recorded. Monitoring of each low level activity of users may be facilitated by reporting responses that are out of tolerance, escalating targeted problems, and video recording remote worker activities. In some examples, system 100 may be attached to a user's mobile phone, desktop, laptop or other communication device to enable the monitoring. In some examples, system 100 may be arranged to monitor geographical motion of a user and to analyze their behavioural patterns or decision patterns. Through activity semantics, system 100 may search for trends and highlight issues that arise when key strokes of workers change.

In an embodiment, the system 100 may employ face recognition to authenticate the user to access the graphical user interface. As a result, authenticated users will be able to access only their dashboards. As discussed above, the system 100 may utilize the mobile devices to determine location of the user on a real time basis when the user has responded or taken an action which is critical to the compliance activity. In another embodiment, the system 100 may associate a global positioning device indicating the position of the user.

For example, in medical business, it is critical that a nurse attending to a patient must be within permissible range of the patient so that the nurse can herself monitor one or more parameters such as heart rate, temperature and the like in order to comply with the regulatory procedures. Failure to comply with the regulatory procedures may result into serious issues such as fatal incidents within the hospital and consequently, the management may have to bear loss in the business. The present system 100 enables the management to associate assurance content related questions for the nurse on the graphical user interface. For example, the question may ask the nurse to record blood pressure of the patient and the nurse is required to respond when she is within the permissible range of the patient or manually monitoring the blood pressure of the patient. The system 100 is adapted to raise an exception if the nurse requests another nurse or a helper to perform the task and does not comply with such requirement as she remain absent while the patient's blood pressure was recorded in the system 100. The global positioning device of the nurse will report to the system 100 that nurse is not within the permissible range of the patient. The system 100 may send alert to a doctor supervising the patient and to the nurse to take a corrective action. Consequently, the system 100 can identify risky patterns in a real time environment.

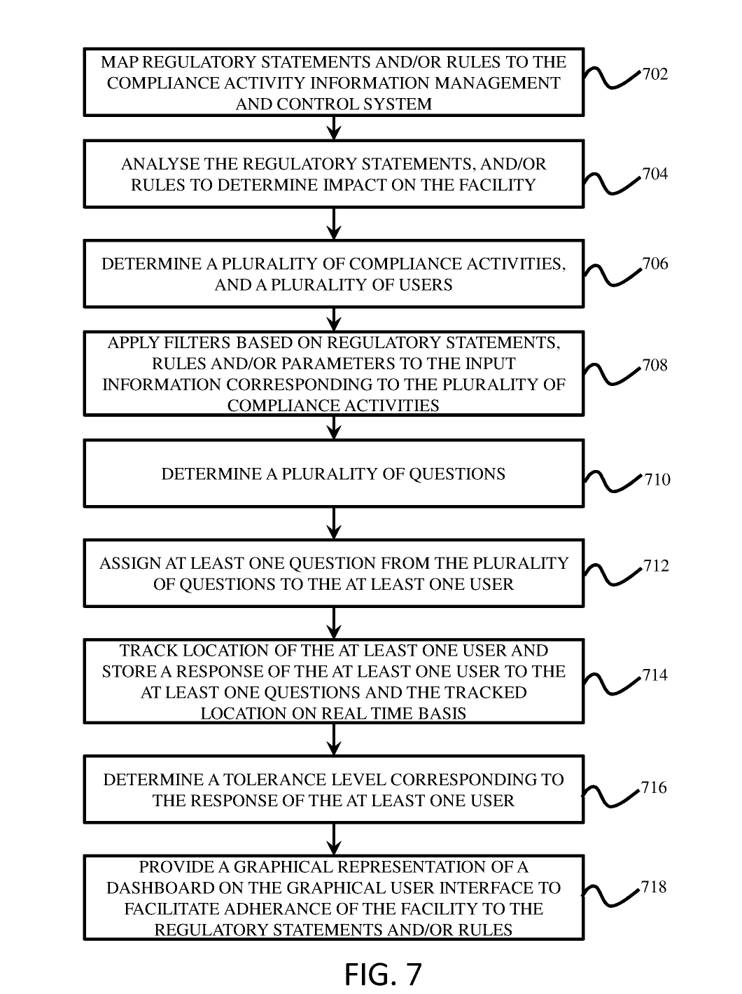

FIG. 7 illustrates an example method of operating a compliance activity information management and control system for use in management of the facility. At 702, a server maps regulatory statements and/or rules to a compliance activity information management and control system.

At 704, the regulatory statements and/or rules are analyzed to determine impact on the facility.

At 706, a plurality of compliance activities and a plurality of users are determined, wherein at least one compliance activity from the plurality of compliance activities is assigned to at least one user of the plurality of users.

At 708, filters based on regulatory statements and/or rules are applied to the input information corresponding to the plurality of compliance activities to extract therefrom information elements describing time-critical processes occurring within the facility, together with supporting information pertinent to the time-critical processes.

At 710, a plurality of questions are determined, wherein the plurality of questions are derived from the information elements and correspond to reusable assurance content. At 712, at least one question is assigned from the plurality of questions to the at least one user. At 714, a location of the at least one user is tracked. In addition, a response of the at least one user to the at least one questions and the tracked location on real time basis is stored.

At 716, a tolerance level corresponding to the response of the at least one user is determined. At 718, a graphical representation of a dashboard on the graphical user interface is provided to facilitate management of the facility, wherein the graphical representation corresponds to at least one exception derived from the tolerance level.

The present systems may be applied to generate automated reward points for each user. System 100 collates information from questions and answers to award the user for good performance. The system may also incentivize training by awarding tokens or gifts for users based on their performance in training task completion. System 100 may also assign training courses to users if their performance is not satisfactory. Training programs may be administered online in an automated manner.

In an embodiment, the system 100 is adapted to generate a knowledge exchange wherein companies may buy the knowledge regarding the assurance activities in order to comply with the industry or regulatory standards. For example, the knowledge exchange may include knowledge statements that can be loaded by users (e.g. industry experts), graded (by other users) and purchased in the system 100. The system 100 may enable experts, regulators, or individuals to disclose their knowledge statements to the system 100. Subsequently, the system 100 vets the statements which may further be offered for sale for stakeholders. A successful sale may result in a reward for creators of the knowledge statements.

Another embodiment of the present disclosure may be used to translate questions and answers from different languages. System 100 is operable to translate questions and answers into different languages which would enable the system 100 to be deployed globally. System 100 recognizes the language of the question or answer upon which the system 100 translates the question or answer into the language desired by the user or any other predetermined language set by the management.

In some examples, system 100 is operable to import data from third party systems to enable automatic assessment of and planning for risk associated with data importation. System 100 is arranged to handle risk and issues associated with tasks or imported data. In some examples, system 100 may be configured to map or link imported data to project planning data. and to interrogate a third party in cases where imported data deviates from previously established tolerance.

Another embodiment of the present disclosure relates to addition or removal of users. System 100 is configured to add or remove users and, moreover, may provide training facilities to new starters to thereby ensure smooth and cost effective transition.

In an example, compliance activity information management and control system 100 may be arranged to manage regulations pertaining to financial conduct. System 100 may be enabled to track a variety of aspects of business operation including but not limited to regulatory compliance, process execution, product development, advertising, data protection, supplier conformance, corporate governance, financial reporting, or combinations of these. Further, system 100 may import data using a common language to facilitate risk aggregation. Moreover, pre-defined checklists ensure that the processes are followed and breached tolerances are reported immediately. By automatically improving regulatory compliance and identifying priority exceptions in real time to escalate them to a nominated stakeholder, risk may be reduced and efficiency may be gained across the facility.

In an another example, compliance activity information management system 100 may be arranged to control initiatives and standardize implementation capability of projects in controlled environments system such as PRINCE2. System 100 may be arranged to automatically monitor projects by sending out pre-defined questions to activity owners and escalating exceptions to a single dashboard. System 100 may contain measurement parameters which enable a methodology such as PRINCE2 to be standardized, risks and issues to be managed, roles and responsibilities to be assigned, project tasks to be pursued, benefit realization to be quantified and lessons to be learned. Through real-time warnings of escalated exceptions system 100 provides tighter control of resources, stakeholders and suppliers. Further, more effective decision-making may be expedited through advanced activity reporting and project management office (PMO) administration costs may be reduced with task automation.

In one example, compliance activity information management system 100 may be arranged to monitor supplier contract adherence and claim service credits. System 100 may be arranged to automatically survey supplier contract terms by sending out pre-defined questions to supplier activity owners and escalating exceptions to a single dashboard. These pre-questions may contain measurement parameters enabling monitoring of delivery risks, managing of stakeholder communication, tracking of service level adherence, supporting of service credit claims and analyzing of supplier performance. Further, system 100 may provide standardization of assurance frameworks and application of best practice contract governance. Therefore, service credit recovery may be improved through real time warnings of service level breaches, decisions may be improved and expedited through advanced activity reporting and administration costs may be reduced with task automation. Every process step and calendar event may be captured such that suppliers become fully accountable across global geographies. Further, system 100 may be arranged for benchmarking analysis of performance statistics thereby strengthening negotiating positions.

In one example, compliance activity information management system 100 may be arranged to deliver successful marketing strategy and build operational excellence. A single source of information may be provided to enable tracking of brand compliance, campaign issues, research and insight initiatives, product development, resource performance and budget monitoring. Data may be automatically collected from activity owners using a common language such that issues are instantaneously escalated to nominated stakeholders. Unique cloud-based technology may be applied to all or part of marketing functions, giving the information to manage by exception. Tighter control of agency contracts may be provided through automated monitoring while benchmarking and performance statistics strengthen negotiating positions. Pre-defined guidelines improve brand visibility and campaign compliance to increase customer satisfaction. A real time dashboard warning of critical issues to enabling efficiency and margin improvements and enhancing decision making.

In another embodiment, the present disclosure can be applied in optimizing a manufacturing facility, technical production apparatus, and technical processing apparatus. System 100, 200 enables early identification of risks that are pending and issues that have already materialized. System 100, 200 facilitates more effective decision making by using higher quality information, sustains an environment with fewer business delays and less overspend, supports a reduction in operational and regulatory compliance risks, creates a framework with lower internal assurance overheads, improves resource performance and productivity, increases stakeholder accountability, and enables proactive service credit recovery from service level agreement breaches. Thus, an improvement in operation of the facility is achieved, for example energy saving, faster production of products, less material resource utilization, and greater commercial profitability, lowers the cost of assurance infrastructure and support teams, standardizes assurance operations and reporting across different business units, cuts out unnecessary meetings, lowers the risk of regulatory contraventions, simplifies on-boarding for new starters by monitoring pre-defined tasks, makes every stakeholder accountable for specific responsibilities, identifies performance improvements through analysis of response data, and reduces an organization's reliance on electronic mail.

To evaluate advantages, system 100 may be installed in a multinational company. Thereafter, system 100 tracks activities to identify divisions where system 100 may be best employed. Points of secondary installation may include contract management divisions. For example, mobile operator contracts for large multinational organizations frequently allow for benefit credits if the operator does not meet an established coverage percentage or network performance. System 100 may be configured to send questionnaires to regional operations and, based upon responses, determine where engineers should be sent. Additionally, benefit credits may be obtained in cases where the operator has broken contract obligations. Moreover, system 100 may additionally track activity of engineers and provide analyses focusing on business efficiency.

Financial services associations monitor activities and non-conformance. In an example, system 100 may be installed in a bank to monitor activities of system users. System 100 ensures regulatory compliance of the activities of a senior manager to avoid liability.

Modifications to embodiments described in the foregoing are possible without departing from the scope of the disclosure as defined by the accompanying claims. Expressions such as “including”, “comprising”, “incorporating”, “consisting of”, “have”, “is” used in the present disclosure are intended to be construed in a non-exclusive manner, namely allowing for items, components or elements not explicitly described also to be present. Reference to the singular is also to be construed to relate to the plural.

What is claimed is:

1. A compliance activity information management and control system including computing hardware arranged to execute computer program products recorded on machine-readable data storage media, wherein the computing hardware is coupled to an input portal to receive input information from an industrial facility, to an output portal for outputting information to the industrial facility, and to a display for providing information to management of the facility, wherein:
the computing hardware is operable to map regulatory statements and/or rules to the compliance activity information management and control system;
the computing hardware is operable to analyze the regulatory statements and/or rules to determine impact on the facility;
the computing hardware is operable to determine a plurality of compliance activities, and a plurality of users, wherein at least one compliance activity from the plurality of compliance activities is assigned to at least one user of the plurality of users;
the computing hardware is operable to apply filters based on regulatory statements and/or rules to the input information corresponding to the plurality of compliance activities to extract therefrom information elements describing time-critical processes occurring within the facility, together with supporting information pertinent to the time-critical processes,
the computing hardware is operable to determine a plurality of questions, wherein the plurality of questions are derived from the information elements and corresponds to reusable assurance content;
the computing hardware is operable to assign at least one question from the plurality of questions to the at least one user;
the computing hardware is operable to track location of the at least one user and store a response of the at least one user to the at least one questions and the tracked location on real time basis;
the computing hardware is operable to determine a tolerance level corresponding to the response of the at least one user; and
the computing hardware is operable to provide a graphical representation of a dashboard on the display to facilitate management of the facility, wherein the graphical representation corresponds to at least one exception derived from the tolerance level.

2. The system as set forth in claim 1, wherein the computing hardware is operable to send additional question or an alert to the at least one user to ensure accountability when the tolerance level is above a threshold tolerance.

3. The system as set forth in claim 1, wherein the computing hardware is operable to:
define a project including a first set of compliance activities from the plurality of compliance activities;
determine a first set of questions from the plurality of questions for the project;
determine a first group of users from the plurality of users, wherein the first set of questions are sent to the first group of users at a predetermined time;
receive responses from the first group of users to the first set of questions;
collate tolerances of the respective responses; and
present exceptions to a management user on the dashboard, wherein the exceptions are derived from the tolerances.

4. The system as set forth in claim 1, wherein the computing hardware is operable to define a hierarchy for each of the plurality of compliance activities, the plurality of questions and the plurality of users.

5. The system as set forth in claim 1, wherein the computing hardware is operable to generate reminders, summary reports and status reports pertaining to the management of the facility and receive instructions for executing control of the facility.

6. The system as set forth in claim 1, wherein the facility includes at least one of: commercial business, manufacturing facility, technical production apparatus, technical processing apparatus.

7. The system as set forth in claim 1, wherein the filters based on regulatory statements and/or rules are at least one of: user-configurable and automatically configurable based on identified processes occurring within the facility.

8. The system as set forth in claim 1, wherein the dashboard presents one or more processes or tasks pertaining to the facility, wherein the one or more processes or tasks are represented by graphical symbols arranged within a Cartesian frame of reference having a first Cartesian axis denoting priority rating of the one or more processes or tasks, and a second Cartesian axis denoting status of the one or more processes or tasks.

9. The system as set forth in claim 1, wherein the dash board is individually user-configurable and supports a plurality of management users via individual or group logins.

10. The system as set forth in claim 1, wherein the computer hardware is operable to automatically generate at least one of:
(a) reminder messages;
(b) automated communication templates for management to employ when controlling the facility; and
(c) workflow functions which link consecutive regulatory statements and/or rules based activities together.

11. The system as set forth in claim 1, wherein the computer hardware is operable to import data automatically from a plurality of third party systems.

12. The system as set forth in claim 1, wherein the computer hardware is operable to translate questions and answers into different languages.

13. The system as set forth in claim 1, wherein the computer hardware includes camera based technology to track and record real time activity of the users.

14. A method of operating a compliance activity information management and control system including computing hardware arranged to execute one or more software products recorded on machine-readable data storage media, wherein the computing hardware is coupled to an input portal to receive input information from an industrial facility, to an output portal for outputting information to the industrial facility, and to a display for providing information to management of the facility, wherein the method includes:
mapping regulatory statements and/or rules to the compliance activity information management and control system;
analyzing the regulatory statements and/or rules to determine impact on the facility;
determining a plurality of compliance activities, and a plurality of users, wherein at least one compliance activity from the plurality of compliance activities is assigned to at least one user of the plurality of users;
applying filters based on regulatory statements and/or rules to the input information corresponding to the plurality of compliance activities to extract therefrom information elements describing time-critical processes occurring within the facility, together with supporting information pertinent to the time-critical processes;
determining a plurality of questions, wherein the plurality of questions is derived from the information elements and corresponds to reusable assurance content;
assigning at least one question from the plurality of questions to the at least one user;
tracking location of the at least one user and store a response of the at least one user to the at least one questions and the tracked location on real time basis;
determining a tolerance level corresponding to the response of the at least one user; and
providing a graphical representation of a dashboard on the display to facilitate management of the facility, wherein the graphical representation corresponds to at least one exception derived from the tolerance level.

15. The method as set forth in claim 14, further comprising:
sending an additional question or an alert to the at least one user to ensure accountability when the tolerance level is above a threshold tolerance.

16. The method as set forth in claim 14, further comprising:
defining a project including a first set of compliance activities from the plurality of compliance activities;
determining a first set of questions from the plurality of questions for the project;
determining a first group of users from the plurality of users, wherein the first set of questions are sent to the first group of users at a predetermined time;
receiving responses from the first group of users to the first set of questions;
collating tolerances of the respective responses; and
presenting exceptions to a management user on the dashboard,
wherein the exceptions are derived from the tolerances.

17. The method as set forth in claim 14, further comprising:
defining a hierarchy for each of the plurality of compliance activities, the plurality of questions and the plurality of users.

18. The method as set forth in claim 14, further comprising: generating reminders, summary reports and status reports pertaining to the management of the facility and receive instructions for executing control of the facility.

19. The method as set forth in claim 14, further including displaying to the dashboard one or more processes or tasks pertaining to the facility that are represented by graphical symbols arranged within a Cartesian frame of reference having a first Cartesian axis denoting priority rating of the one or more processes or tasks, and a second Cartesian axis denoting status of the one or more processes or tasks.

20. The method as set forth in claim 14, further including individually configuring the dashboard to support a plurality of management users via individual or group logins.
